(19) United States
(12) Patent Application Publication
(10) Pub. No.: US 2014/0327768 A1
(43) Pub. Date: Nov. 6, 2014

(54) SYSTEM AND METHOD FOR MONITORING AND AUDITING REMOTE FACILITIES

(71) Applicant: Greg Lane Marshall, Schaumburg, IL (US)

(72) Inventor: Greg Lane Marshall, Schaumburg, IL (US)

(21) Appl. No.: 14/334,759

(22) Filed: Jul. 18, 2014

Related U.S. Application Data
(63) Continuation-in-part of application No. 13/544,639, filed on Jul. 9, 2012.

(51) Int. Cl. G06T 7/00; H04N 7/18

(52) U.S. Cl. CPC G06T 7/0038; H04N 7/183
USPC 348/143

(57) ABSTRACT

A system and method for operating the same is disclosed in the present invention. Data are collected from remote facilities by data collecting devices, transmitted via means of data transmission to data server center for processing and compiling. The compiled data then are used to generate notifications and reports to clients interested in the remote facilities for the purpose of remote facility audit and management.

### CROSS REFERENCE TO RELATED APPLICATIONS

This application is a continuation-in-part of U.S. patent application Ser. No. 13/544,639, entitled “METHOD AND SYSTEM FOR REMOTE FACILITY AUDIT AND MANAGEMENT,” filed Jul. 9, 2012, which is hereby incorporated by reference in its entirety.

### FIELD OF THE INVENTION

The present invention relates to a system and method for remote monitoring. In particular, the present invention relates to a system and method of operating the same for remote facility audit and management.

### DESCRIPTION OF BACKGROUND

Many companies have remotely operated facilities and remotely constructed projects. Such companies typically include cellular carriers, tower companies, turf vendors, and contractors and others. Since most of the projects have been moving so fast with sub-contractors of sub-contractors, these companies have little knowledge of the current site configuration and when people are performing work on site. Most of the remote facilities of these companies are operated in an unmanned fashion, there are great concerns of the securities of the materials and equipments at the remote facilities, such security risks includes vandalism, theft or natural severe weather conditions.

What is needed is a method and a system for tracking who is on site and/or on the tower, what is on the remote premise, and when it was changed or modified. There is a further need to audit the events and changes, and provide notifications of the events and changes to interested parties.

### OBJECTS OF THE DISCLOSED SYSTEM, METHOD, AND APPARATUS

Accordingly, it is an object of this disclosure to provide a system and method for monitoring and auditing remote facilities.

Another object of this disclosure is to provide a remote facility monitoring system and method utilizing imaging devices, including digital cameras and sensors.

Another object of this disclosure is to provide a remote facility monitoring system and method for providing real-time or near real-time monitoring.

Another object of this disclosure is to provide a remote facility monitoring system and method for detecting variance in images and providing notification of such variance.

Another object of this disclosure is to provide a remote facility monitoring system and method for providing real-time or near real-time auditing.

Another object of this disclosure is to provide a remote facility monitoring system and method for providing remote facility audit results to interested parties.

Other advantages of this disclosure will be clear to a person of ordinary skill in the art. It should be understood, however, that a system or method could practice the disclosure while not achieving all of the enumerated advantages, and that the protected disclosure is defined by the claims.

### SUMMARY OF THE DISCLOSURE

In an exemplary embodiment of the present invention, there is disclosed a system and method for operating the same for remote facility audit and management. The system is comprised of remotely deployed data collecting devices installed or attached to the remote facilities, means for data transmission and communication, and data server center for data processing and compiling. The method for remote facility audit and management comprises 1) deploying the said system for the companies who have interests in remote facilities, 2) remotely operating the data collecting devices, 3) collecting data from remote facilities for these companies via data collecting devices, 4) transmitting and communicating the collected data to data server center, 5) processing and compiling the collected data at the data server center, and 6) notifying these companies the human activities such as man on tower detection, equipment modifications, additions, deletions, new construction, potential vandalism, theft, or other situations and/or providing material/equipment audits of the remote facilities.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

Generally speaking, pursuant to the various embodiments, the present disclosure provides a system for monitoring and auditing a remote facility. In accordance with the present teachings, the system includes a database and a server. The server includes a processor, a network interface coupled to the processor and adaptively coupled to the database, and a server software application running on the processor. The server is adapted to communicate with a plurality of imaging devices and a set of workstations. The plurality of imaging devices includes a first imaging device mounted to a remote facility. The first imaging device is adapted to capture images and upload the captured images to the server. The set of workstations includes a first workstation. The server software application is adapted to, from the first imaging device, retrieve a first image and a second image via the network interface. The server software application is further adapted to determine a time for both the first image and the second image, and compare the first image with the second image to determine that there is an image variance between the first image and the second image. Moreover, the server software application is adapted to audit the remote facility when the image variance is detected.

Further in accordance with the present teachings is a method for monitoring and auditing a remote facility. The method operates within a remote facility monitoring and auditing system, and includes receiving a first image and a second image from an imaging device over a network interface of a server within the system. The imaging device is mounted to a remote facility and adapted to communicate with the server over a network connection. The method also includes determining a time for both the first image and the second image, and comparing the first image with the second image to determine that there is an image variance between the first image and the second image. In addition, the method includes auditing the remote facility in response to the image variance.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals. Although the characteristic features of this disclosure will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a schematic illustration of the present invention as a system and method for operating the same for remote facility audit and management.

FIG. 2 is simplified block diagram of a system for monitoring and auditing remote facilities in accordance with this disclosure.

FIG. 3 is a simplified block diagram of a remote facility with mounted imaging devices in accordance with this disclosure.

FIG. 4 is a flowchart depicting a process by which a server detects an image variation and provides a notification of such variation in accordance with this disclosure.

FIG. 5 is a flowchart depicting a process by which a server compares the two images to determine that there is an image variation between the two images in accordance with this disclosure.

FIG. 6 is a flowchart depicting a process by which a server compares the two images to determine that there is an image variation between the two images in accordance with this disclosure.

FIG. 7 is a sequence diagram depicting a process by which a remote facility monitoring and auditing system monitors and audits a remote facility and provides notifications to an interested party in accordance with this disclosure.

FIG. 8 is a sequence diagram depicting a process by which a remote facility monitoring and auditing system monitors and audits a remote facility and provides notifications to an interested party in accordance with this disclosure.

FIG. 9 is a sequence diagram depicting a process by which a remote facility monitoring and auditing system monitors and audits a remote facility and provides notifications to an interested party in accordance with this disclosure.

FIG. 10 is sequence diagram depicting a process by which a remote facility monitoring and auditing system captures preset images and generates time lapse videos in accordance with this disclosure.

FIG. 11 is a flowchart depicting a process by which a server filters off images captured while light is off in accordance with this disclosure.

A person of ordinary skills in the art will appreciate that elements of the figures above are illustrated for simplicity and clarity, and are not necessarily drawn to scale. The dimensions of some elements in the figures may have been exaggerated relative to other elements to help understanding of the present teachings. Furthermore, a particular order in which certain elements, parts, components, modules, steps, actions, events and/or processes are described or illustrated may not be actually required. A person of ordinary skills in the art will appreciate that, for the purpose of simplicity and clarity of illustration, some commonly known and well-understood elements that are useful and/or necessary in a commercially feasible embodiment may not be depicted in order to provide a clear view of various embodiments in accordance with the present teachings.

### DETAILED DESCRIPTION

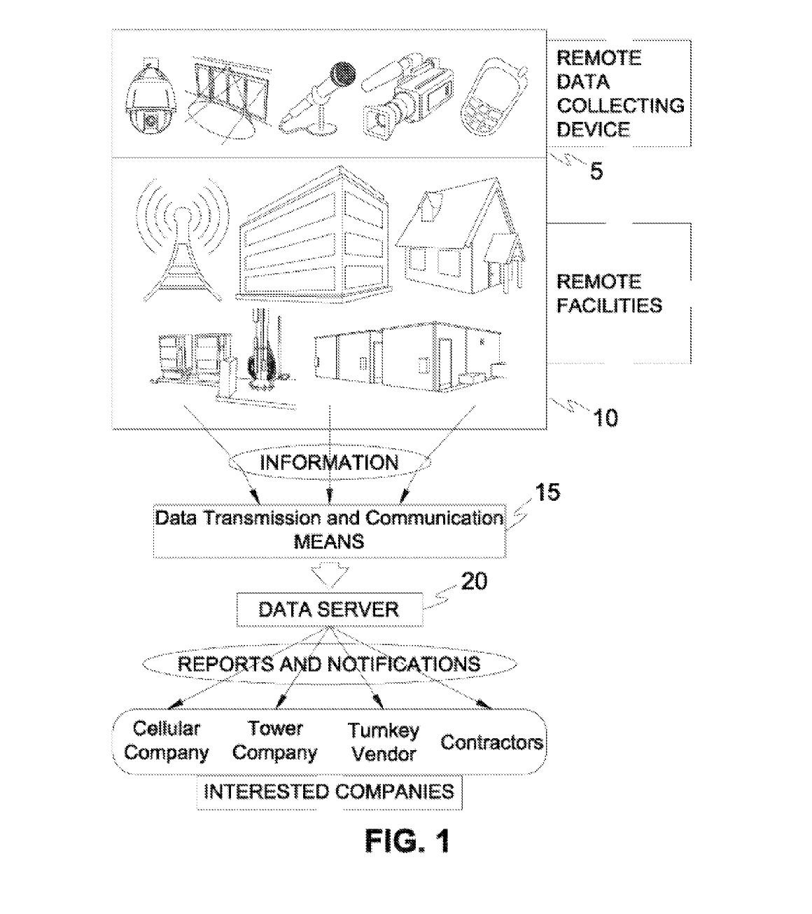

Referring to FIG. 1, there is disclosed a system and method for operating the same for remote facility audit and management. The system comprises of remotely deployed data collecting devices 5 installed or attached to the remote facilities 10, means for data transmission and communication 15, and data server center 20 for data processing and compiling.

In the presently disclosed system, one or multiple data collecting devices 5 in the present invention can be installed or attached to the remote facilities and towers. Such devices can include but not be limited to video cameras, audio, thermal imaging, Passive Infrared (“PIR”) sensors or other motion detection devices, in ground sensors, contact closures on shelter door(s), contact closures on both outdoor and indoor equipment cabinets, or any other device that can detect human presence around the facility compound. The remote facilities 10 in the present invention can include but not be limited to Data Centers, Radio Frequency (“RF”) telecommunications towers, roof tops, water tanks, RF compound facilities including RF shelters, and outdoor telecommunication cabinets, telecommunication central offices, or any important unmanned telecommunication facility.

In the presently disclosed system, the means for data transmission and communication 15 are used to transmit or communicate the data collected by remote data collecting devices 5, such as video, audio, images, motion detection, gate contact closure, cabinet contact closure, shelter door contact closure, other contact closure(s), or any other information collected from the remote facilities to data server center 20 for data processing and compiling. The means for data transmission and communication can be any network method which could include Internet Protocol (“IP”) packet, Time-division multiplexing (“TDM”), or any other method that can transmit or communicate the data collected from the remote facilities. Some methods could include broadband wireless, cable modems, private IP networks, the Internet, subscriber based networks, fiber optic networks, copper networks, or any other viable method of transmission of the information. The data can be encrypted, but does not have to be when transmitted between devices.

In the presently disclosed system, the data server center 20 can be one or more regional or national centers.

In one embodiment of the presently disclosed system, one camera is installed on Monopole with RAD center at top of pole. The said camera could account for all three sectors. One or more cameras could be at ground level and/or in shelters, one or more detection devices could have the capability to serve all carriers on tower and in the compound.

In another embodiment of the presently disclosed system, three cameras are installed for a Monopole, one for each sector, for a RAD center that is not at the top. If more than one Carrier was interested in this service offering, each Carrier could have cameras for each of their own RAD centers. One or more cameras at ground level and/or shelter, one or more detection devices could have the capability to serve all carriers on tower and in the compound.

In another embodiment of the presently disclosed system, three cameras are installed for a Guyed, one for each sector, for a RAD center that is not at the top. If more than one Carrier was interested in this service offering, each carrier could have cameras for each of their own RAD centers. One or more cameras at ground level and/or shelter, one or more detection devices could have the capability to serve all carriers on tower and in the compound.

In another embodiment of the presently disclosed system, three cameras are installed for a Self Support, one for each sector, for a RAD center that is not at the top. If more than one Carrier was interested in this service offering, each carrier could have cameras for each of their own RAD centers. One or more cameras at ground level and/or shelter, one or more detection devices could have the capability to serve all carriers on tower and in the compound.

In another embodiment of the presently disclosed system, cameras are installed in a customized manner on rooftop based on the antenna placement/configuration. Each site could require one camera per sector and additional cameras could be required to cover all entry and exit points on the roof for security purposes.

In another embodiment of the presently disclosed system, cameras are installed in a customized manner to water tanks based on the antenna placement/configuration. Each site could require one camera per sector and additional cameras could be required to cover all entry and exit points for security purposes.

Also referring to FIG. 1, there is disclosed a method for operating the said system for remote facility audit and management. The method comprises 1) deploying the said system for the companies who have interests in remote facilities, 2) remotely operating the data collecting devices, 3) collecting data from remote facilities for these companies via data collecting devices, 4) transmitting and communicating the collected data to data server center, 5) processing and compiling the collected data at the data server center, and 6) notifying these companies the human activities such as man on tower detection, equipment modifications, additions, deletions, new construction, potential vandalism, theft, or other situations and/or providing material/equipment audits of the remote facilities.

In the presently disclosed method, the data collecting devices installed or attached to the remote facilities are used to collect data from remote facilities. Such data collecting devices can include but not be limited to video cameras, audio, thermal imaging, PIR or other motion detection devices, in ground sensors, contact closures on shelter door(s), contact closures on both outdoor and indoor equipment cabinets, or any other device that can detect human presence around the facility compound. The data collected via these devices can be video, audio, images, motion detection, gate contact closure, cabinet contact closure, shelter door contact closure, other contact closure(s), or any other information collected from the remote facilities. The remote facilities to where the data collecting devices are installed or attached and from where the data are collected can include but not be limited to Data Centers, RF telecommunications towers, roof tops, water tanks, RF compound facilities including RF shelters, and outdoor telecommunication cabinets, telecommunication central offices, or any important unmanned telecommunication facility.

In the presently disclosed method, the data collecting devices are connected, and the data collected by these data collecting devices are transmitted to data server center via means of data transmitting and communicating. The means for data transmission and communication can be any network method which could include IP packet, TDM, or any other method that can transmit or communicate the data collected from the remote facilities. Some methods could include broadband wireless, cable modems, private IP networks, the Internet, subscriber based networks, fiber optic networks, copper networks, or any other viable method of transmission of the information. The data can be encrypted, but does not have to be when transmitted between devices.

In the presently disclosed method, after data collected from the remote facilities are transmitted via means of transmitting and communicating to the data server center which can be one or more regional or national centers, the data could be passed through to the client via real time video and/or processed and compiled at the said data server center.

Different methods are used to process and compile data collected from remote facilities according to clients' goals. For example, to capture any and all equipment/material modifications and/or additions/deletions that have occurred either on the remote towers, buildings, shelters, or other structures within the remote compounds, an algorithm has been created to compare electronic images from the day before any modifications/additions/deletions were detected and compare data of any and all activities of the day activity detection occurred. The algorithm output using pixel and other data point comparison will produce reports, alerts, etc., outlining any and all changes that occurred at any given location. As part of the algorithm function, precautions are built into the logic to account for and consider gate openings and man on tower activity to eliminate or reduce the number of image comparisons required to capture real activity from false readings that can occur due to inclement weather such as snow on the equipment. All captured activity either by the algorithm or by human supervision will be collected and reported to all interested parties.

Another example is to use multiple preset in combination with time lapse camera functionality. Custom software scripts were developed to control a Pan Tilt Zoom (PTZ) camera to cycle through specified preset positions within each hour and take a snapshot for each and send the photo image file where it can be combined with others to create time lapse photography. The combination of telling the camera to move to a specific position and take a time lapse snapshot allows creation of multiple time lapse video views. When the camera is commanded to take a snapshot it names the file for that photo by it's PTZ Position Number along with the time and date. This allows assembly of many photos into separate time lapse video archive streams. A single camera or each camera in a large system could produce more time lapse videos and each having multiple views and thus creating multiple time lapse videos from each.

After data collected from remote facilities has been processed and compiled, notifications and/or reports are generated from the compiled data and provided to companies with interests in those remote facilities (client). The compiled data from the remote facilities could trigger alarms and other desired notifications related to the aforementioned human activities for the purpose of distributing information to any client's designated Network Operations Centers, data servers, or other designated facility or entities of choice to help support their maintenance, construction and or audit activities, either real time, on a defined periodic schedule, or as poled by the client. A portion of the compiled data will also be used to generate a repeating video showing last activity, a time lapse function that will be made available indicating time and date stamps of all human activity on the tower such as tower maintenance, equipment expansions and/or modifications, and all other activity in the facility compound and shelter. Store and compare functions from captured video will also be made available to clients to facilitate check and balances for all work performed over a specified period of time.

In one embodiment of the presently disclosed method, the method is used and the notifications and reports are provided for the purpose of real time up-to-date equipment/material audits for tower top, shelters, and outdoor cabinets. The notifications and reports could 1) provide immediate checks and balances by comparing data stored in data bases such as Siterra, etc; 2) improve RF design with an accurate RFDS; 3) improved system performance; 4) shorten deployment schedules; 5) reduces trips to site and deployment costs; and/or 6) improve customer satisfaction.

In another embodiment of the presently disclosed method, the method is used and the notifications and reports are provided for the purpose of monitoring tower climbing. Real time or delayed time lapse video in conjunction with real time or delayed alert messaging for all tower climbing activities can be sent to the client's data server, Regional or National NOC (National Operation Center) via multi media of choice. The notifications and reports could 1) provide immediate notification of someone on tower; 2) trigger monitoring and documentation activities for all equipment modifications, adds, and deletions as they occur; 3) capture actual dates that equipment/material was installed on the tower to enforce accurate dates that trigger new lease amendments. It will aid in keeping tenants honest regarding installation dates to minimize lost monthly reoccurring revenues; 4) monitor and document if proper climbing protocols and safety standards were followed. This will offer the ability of the tower owner to take immediate action to mitigate climbing accidents and/or deaths; 5) ensure/enforce proper construction and equipment installation standards are followed without being on site; and/or 6) monitor daily construction activities remotely for multiple site locations. Split screen mode will allow user to view multiple construction sites on one screen real time.

In another embodiment of the presently disclosed method, the method is used and the notifications and reports are provided for the purpose of monitoring construction activities. Real time or delayed time lapse video in conjunction with real time or delayed alert messaging for all construction activities and equipment/material modifications can be sent to the client's data server (Regional or National NOC) via multi media of choice. The notifications and reports could be use by the clients for the purpose of 1) verifying and monitoring construction activities without personnel on site—bringing immediate accountability to contractor with less effort; 2) verifying installation quality standards are being met real time without being on site and without the need for tower climbers for tower top inspections; 3) verifying proper safety standards (such as wearing proper harness) are being met during construction—either real time or capture history for later review; 4) verify if the correct material/equipment is being installed properly without the need of visiting the site; 5) monitoring daily construction activities remotely for multiple site locations using split screen mode to view multiple construction sites on one screen real time; 6) determining daily progress by construction crew by using image overlay function; and/or 7) generating historical records of weather conditions and effect on construction, when crews were on site, or when milestone phases were completed.

In another embodiment of the presently disclosed method, the method is used and the notifications and reports are provided for the purpose of monitoring maintenance activities. Real time or delayed time lapse video in conjunction with real time or delayed alert messaging for all maintenance activities can be sent to the client's data server (Regional or National NOC) via multi media of choice. The notifications and reports could be used by the clients for the purpose of 1) aiding RF and Operations in trouble shooting poor cell site performance after inclement weather. Time Lapse in conjunction with real time video can aid personnel in determining if there is damaged equipment on ground level or on tower without a site visit; and/or 2) monitor vendor/contractor work to improve productivity by accurately assessing activities that can slow production without a site visit.

In another embodiment of the presently disclosed method, the method is used and the notifications and reports are provided for the purpose of security. Real time or delayed time lapse video in conjunction with real time or delayed alert messaging for security purpose can be sent to the client's data server (Regional or National NOC) via multi media of choice. The notifications and reports could be used by the clients for the purpose of 1) capturing activities associated with theft and vandalism that provide a deterrent and lead to more convictions. Extremely bright lights and/or sirens can be activated when activity is detected in restricted areas. Video images can be forwarded on such occurrences for human analysis and to enable further action to be taken if required; 2) minimizing repeat offenders and occurrences in known crime areas; 3) discouraging contractors and hired help from stealing or removing equipment without authorization; 4) improving equipment inventory management by determining if equipment was actually delivered to site location and verifying equipment delivery dates; 5) recording vehicles as they enter/exit site; and/or 6) verifying work site is locked up properly.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are entitled.

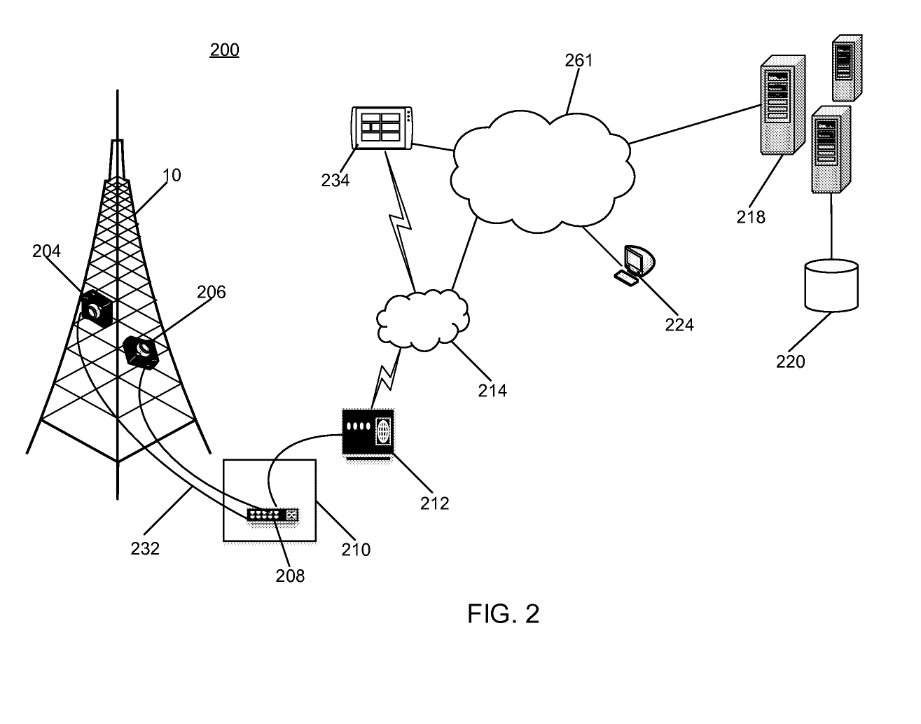

The remote facility audit and management system is further illustrated by reference to FIGS. 2, 3, 4, 5, 6, 7, 8 and 9. Turning first to FIG. 2 in particular, a system for monitoring and managing remote facilities is shown and generally indicated at 200. The illustrative system 200 includes a server 218 operatively coupled to a database 220. In one implementation, the server 218 is a server system comprising a plurality of servers. The plurality of servers is distributed in one or more physical locations. Alternatively, the server 218 is a cloud based server. The server 218 is connected to a wide area network 216, such as the Internet. The server 218 includes some amount of memory, a network interface for connecting to the Internet 216, and a processor for running one or more server software applications written using computer programming languages, such as Java, C#, PHP, etc. The server software application accesses the database 220 for storing and retrieving data. The database 220 is, for example, a relational database (such as an Oracle database, SQL database, or MySQL database), or a Siterra database.

The system 200 also includes one or more workstations 224, such as desktop computers, laptop computers, tablet computers, etc. The workstation 224 runs a workstation software application, such as a web browser or proprietary software application, to communicate with the server software application. Example web browsers are Google's Chrome and Microsoft's Internet Explorer. The workstation 224 communicates with the server 218 over the Internet 216 or a private network, such as a corporate Ethernet local area network. In a further implementation, the system 200 includes a communication device 234 operated by a third-party. The device 234 can be, for example, a computer or a telephone that is operatively coupled to the Internet 216, a wireless network 214 (such as a public cellular network). The communication device 234 can also be a server of a customer of the system 200.

The system 200 further includes a set (meaning one or more) of imaging devices 204 and 206 mounted to the remote facility 10, such as a radio tower, a roof top, a water tank tower, a central office, a data center, etc. Though only two imaging devices 204 and 206 are shown, a person of ordinary skill will appreciate that additional imaging devices can be deployed within the scope of the present teachings. The imaging devices 204 and 206 can be, for example, video cameras, thermal imaging devices, PIRs, etc. The imaging devices 204 and 206 are also referred to herein as data collecting devices. The imaging devices 204 and 206 are connected to, for example, a Power Over Ethernet Switch (“POES”) 208 located inside an enclosure 210, such as a shelter or cabinet. In one embodiment, the video cameras 204 and 206 are wired to the POES 208 using outdoor rated CAT 5 cables 232. The CAT 5 includes both power and data lines. The power line provides power to the cameras 204 and 206, while the data lines are used to transmit data from and/or to the cameras 204 and 206.

The POES 208 is connected to a wireless modem 212, which is connected to the Internet 216 over the wireless network 214. Using the POES 208 and the wireless modem 212, the imaging devices 204 and 206 send image data to the server 218. In a further implementation, the server software application running on the server 218 controls and configures the imaging devices 204 and 206 over the Internet 216, the wireless network 214, the wireless modem 212, and the POES 208. The image data captured by the imaging devices 204 and 206 can be transmitted to the server 218 via various types of network, such as broadband wireless networks, cable modem connections, private IP networks, the Internet 216, subscriber based networks (such as public cellular networks), fiber optic networks, and copper networks. In a further implementation, when it is transmitted to the server 218, the image data is encrypted for increased security. In a further implementation, a communication device, such as an embedded computer, is disposed locally at the site of the remote facility 10 that bridges the communication between the devices 204 and 206 and the server 218. The embedded computer serves to manage the imaging devices 204 and 206, and provides system scalability and other system benefits.

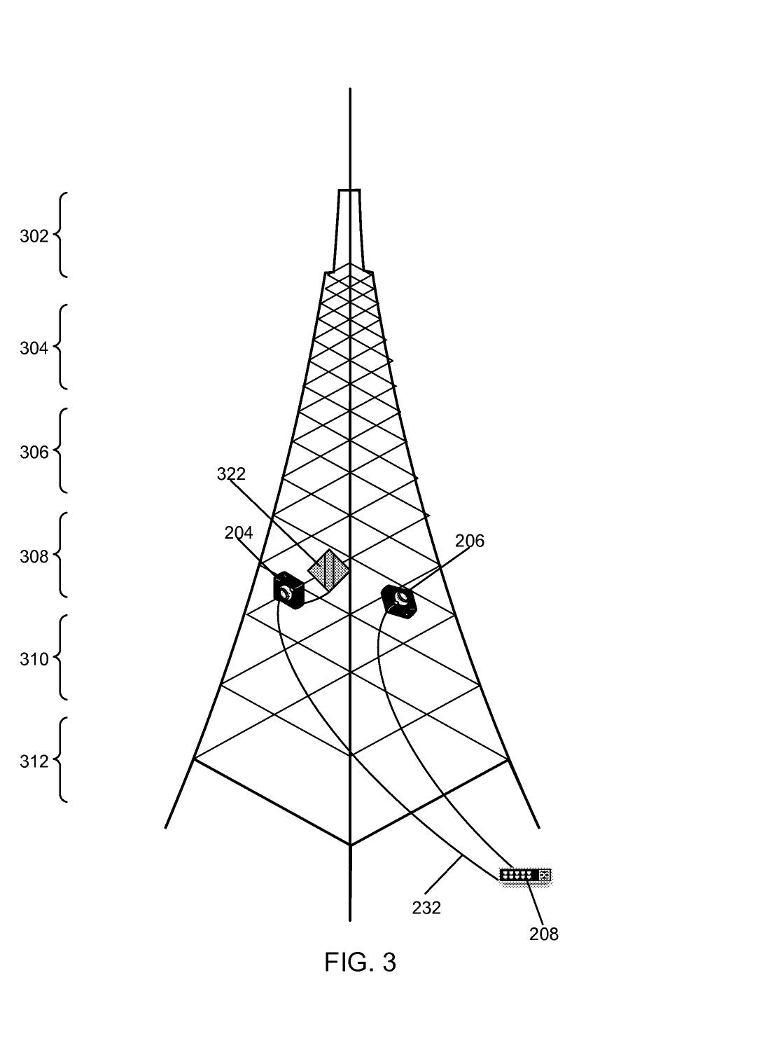

The remote facility 10, such as a telecommunication tower, is usually leased to telecommunication carriers by the tower operators/owners. The tower space of the tower 10 is generally identified by a specified height on the tower 10 at which the carrier is permitted to install its communication equipment, including antennas. The tower space at a specific height is referred to as a RAD center, which if further illustrated by reference to FIG. 3.

Referring to FIG. 3, a list of RAD centers is indicated at 302, 304, 306, 308, 310 and 312. The illustrative imaging devices 204 and 206 are installed in the RAD center 308. Usually, there needs to be some space between adjacent RAD centers in compliance with regulations. Each RAD center usually has three sectors. For example, the imaging devices 204 and 206 are installed in different sectors of the RAD center 308 for monitoring the RAD center 308. The imaging devices 204 and 206 monitor various activities, events and equipment installation/modification. For example, they monitor tower climbing by a maintenance professional, equipment modifications and changes, climbing protocol compliance by climbers, safety standard compliance, construction activities, presence of a specific type of object (such as a bird), etc.

In one implementation, the imaging devices 204 and 206 are digital cameras with remote pan, tilt, zoom, on board RAM (Random Access Memory) storage capabilities. The capabilities of the cameras 204 and 206 are further defined by their digital video resolution, frames per second, panning and tilt ranges, optical digital zoom ranges, outdoor temperature ratings for both subzero and very hot climates, stealth/convert, night vision, thermal imaging, supported networking protocols, supported network link speed (such as Ethernet 10 BaseT and 100 TX).

In a further implementation, additional imaging devices, such as a PIR sensor 322 or other types of motion detection devices is installed in the RAD center 308. The PIR sensor 322 is linked to the imaging device 204. The imaging devices for detecting motion include thermal imaging devices, in ground sensors, contact closures, etc. For example, the PIR sensor 322 is configured to detect a human being, such as a maintenance worker climbing on the tower 10.

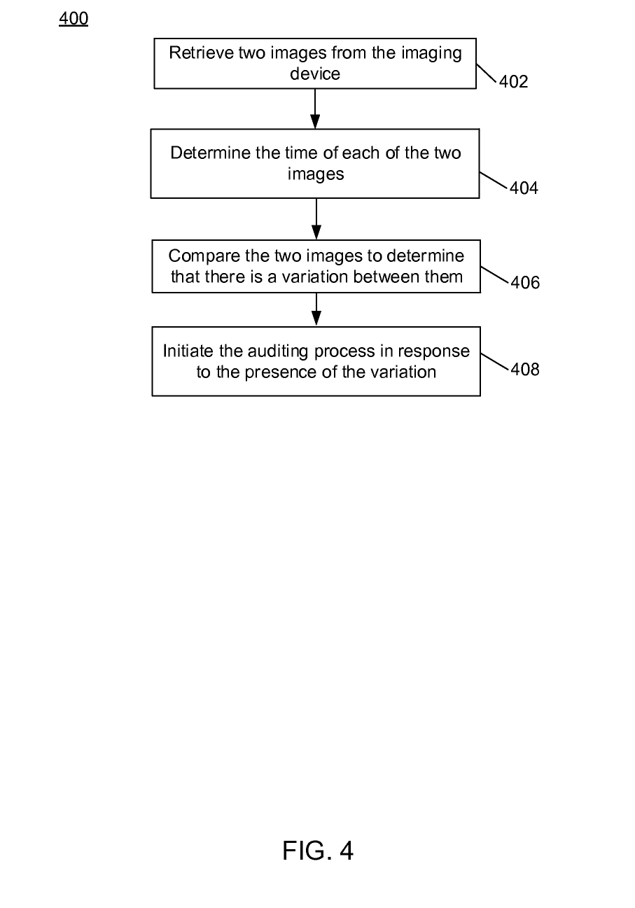

The monitoring of the RAD centers and the facility 10 is further illustrated by reference to FIG. 4. Turning to FIG. 4, a flowchart depicting a process by which the server software application detects an image variation and provides a notification of such variation is shown and generally indicated at 400. At 402, the server software application retrieves two images from the imaging device 204 (or 206). The two images are two consecutive images because the device 204 periodically (such as every one minute, five minutes, one hour, etc.) captures images and send them to the server 218. The two images are also referred to herein as the first image and the second image respectively. The second image is captured after the first image. It should be noted that the two images are captured by the same imaging device 204, and thus have the same pixel dimensions and color depth. At 404, the server software application determines the time of each of the received images. In one implementation, the time of an image is the time when the image is received by the server 218. Alternatively, the device 204 provides the time, which is the time when the image is captured. For example, the capture time is embedded in the image's meta data fields.

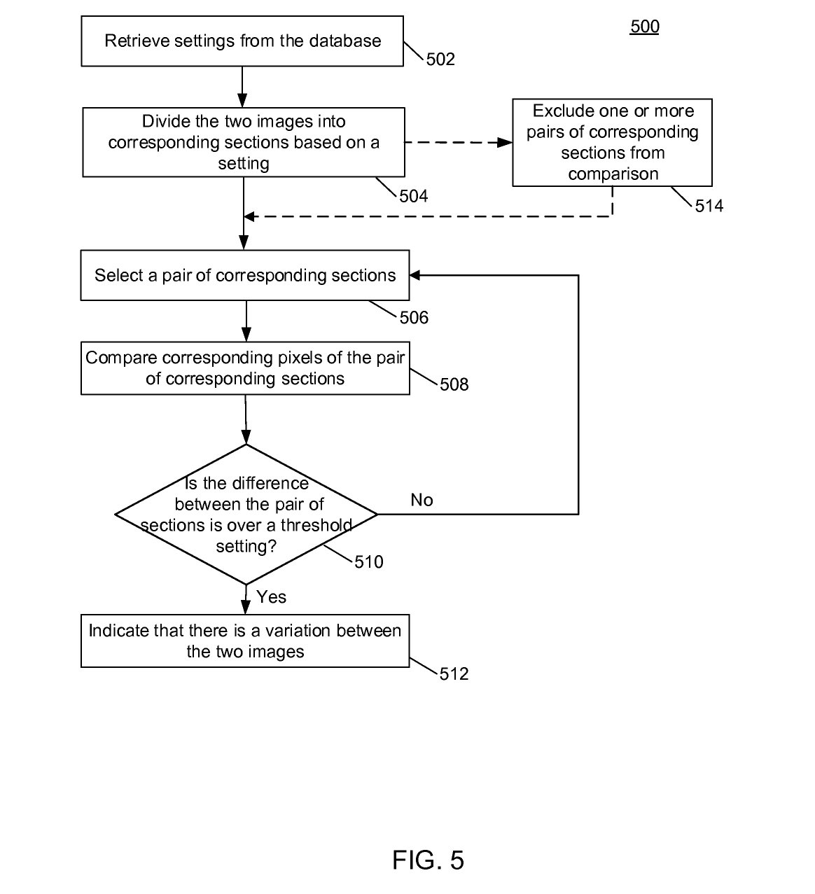

In a further implementation, the server software application stores the time of each image into the database 220. The stored time is associated with the specific image, the imaging device 204 and the facility 10. In another implementation, the images are stored into, for example, the database 220 or a file system after they are received. At a later time, the process 400 is performed on the stored images by retrieving the images and the time of each of the images from the database 220. At 406, the server software compares the two images to determine that there is a variation between the two images. At 408, the server software initiates an auditing process in response to the detection of the presence of the variation. The elements 406 and 408 are further illustrated by reference to FIGS. 5, 6, 7, 8 and 9.

Turning first to FIG. 5, a flowchart depicting a process by which the server software application compares the two images to determine that there is a variation between the two images is shown and generally indicated at 500. At 502, the server software application retrieves a set of settings from the database 220. One of such settings indicates how an image is divided for comparison. For example, an image is not divided when image comparison is performed on it. As an additional example, an image is divided into four equal quadrants from the center of the image.

At 504, the server software application divides the two images into corresponding sections based on the division setting retrieved at 502. For example, each image is divided into four quadrants. The four quadrants of the first image correspond to that of the second image in the sense that the corresponding quadrants have the same geometric position and dimension. It should be noted that the division can be a logical division without separating each image into different images in memory, a file system or the database 220.

At 506, the server software application selects a pair of corresponding sections, such as the first pair of quadrants, for image comparison. At 508, the server software application compares the selected pair of corresponding sections. In one implementation, the server software application compares the colors of each pair of corresponding pixels of the pair of corresponding sections. The pair of corresponding pixels have the same coordinates. Two pixels are regarded as different if the difference between their colors exceeds a threshold (a setting retrieved at 502). In such a case, the pixel in the second image is referred to herein as a changed pixel. The pixel color threshold depends on, for example, a sensitivity parameter of a digital camera. For example, when the sensitivity parameter is set to a higher value, a lower difference between the colors of the two pixels is required to indicate that the pixels are different. The percentage of pixels with different colors between the two corresponding sections is a measure of the difference between the two sections. It should be noted that other measures can be used to indicate the difference between the corresponding sections.

At 510, the server software application checks whether the difference is over a threshold (a setting retrieved at 502). If so, at 512, the server software application indicates that there is a variation between the two images. For example, the server software application updates the database 220 to indicate the variance. The database update indicates, for example, the facility 10, the imaging device 204, the time of the first and second images, and the existence of the variance. The indication can also be stored in memory. Turning back to 510, if the difference not over the threshold, at 506, the server software application selects the next pair of corresponding sections for comparison. When each pair of corresponding sections has been compared, the process 500 terminates. When there is not a variance between any pair of corresponding sections, the server software application determines that there is not a variance between the two images.

In a further implementation, at 514, the server software application excludes one or more pairs of corresponding sections from the image comparison. For example, when the field-of-view (“FOV”) of the imaging device 204 includes a busy road, it is desirable to exclude the section including the road from comparison. The exclusion is based on a predetermined setting that is retrieved at 502. As an additional example, when it is desirable to monitor only a section, only a single pair of corresponding sections is compared by the process 500; and the rest of the pairs of the corresponding sections are excluded.

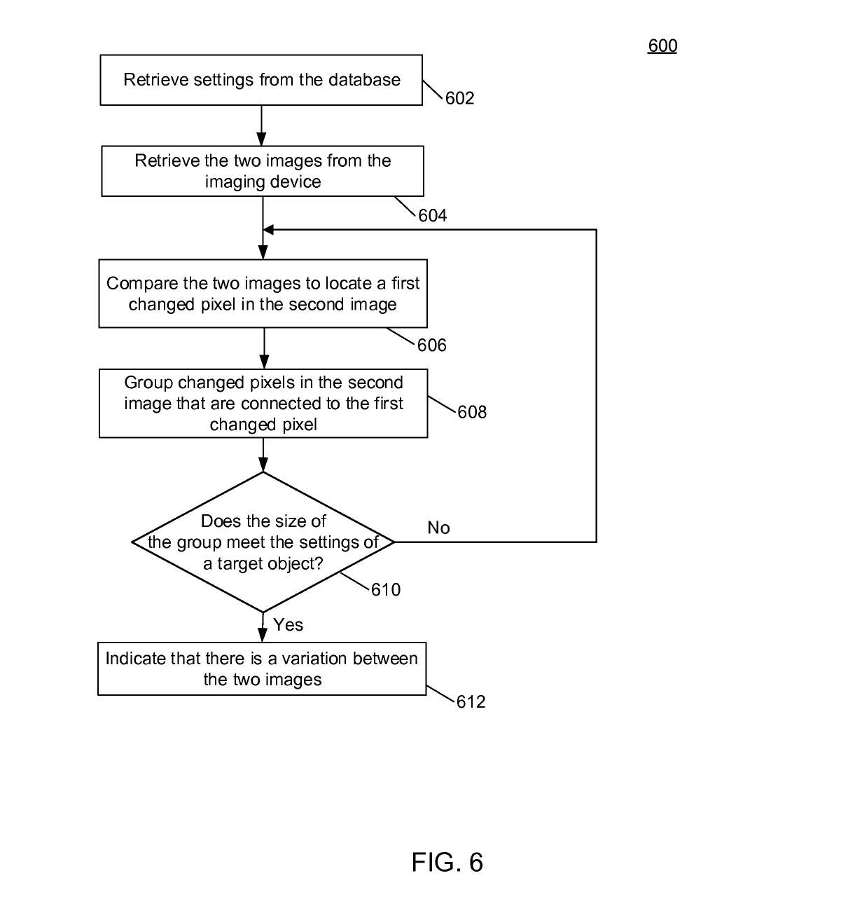

Referring to FIG. 6, a flowchart depicting an alternate process by which the server software application compares the two images to determine that there is a variation between the two images is shown and generally indicated at 600. At 602, the server software application retrieves a set of settings from the database 220. For example, one setting in the set of settings defines the criteria (such as size) of a target object. At 604, the server software application retrieves the two images from the imaging device 204. It should be noted that the two images could be retrieved from the database 220, a FTP server, etc. At 606, the server software application enters a loop to compare the two images to locate a first changed pixel in the second image. At 608, the server software application groups changed pixels in the second image that are connected to the first changed pixel.

As used herein, two changed pixels are termed to be connected if they are close to each other, either horizontally or vertically. In other words, they are connected if their x coordinates or y coordinates differ by a predetermined threshold. The predetermined threshold can be one, two, three or more pixels, depending on the specific implementations. Alternatively, two changed pixels are said to be connected if their x coordinates or y coordinates differ by the predetermined threshold. Two changed pixels are also termed to be connected if there are a list of changed pixels, including the two changed pixels, that any two adjacent pixels in the list are connected.

At 610, the server software application determines whether the size (such as the number of pixels) of the grouped pixels meet the settings of a target object. For example, the settings of a target object define a size range. When the size of the group falls within the range, at 612, the server software application indicates that there is a variance in the images. For example, the variance in the images is a highlighted pixel group including the variance. Otherwise, at 606, the server software application searches and locates the next changed pixel, and detects a variance in a looping manner.

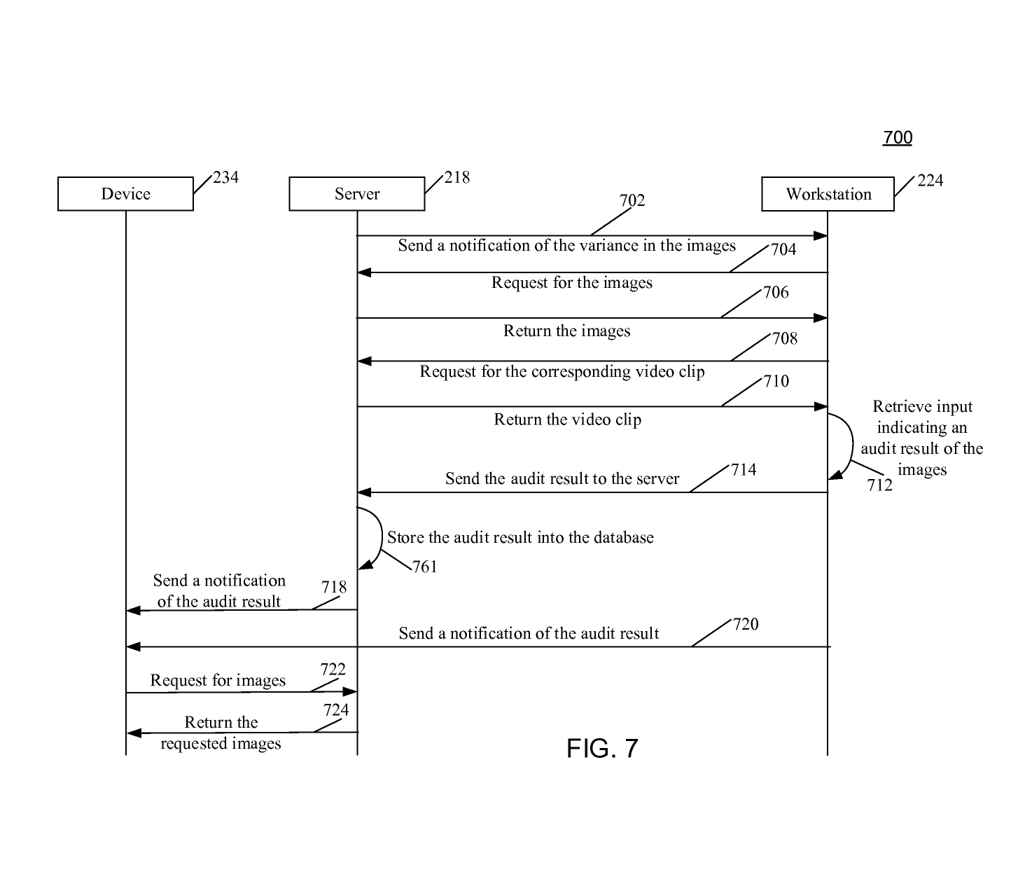

After a variance is detected, the server software application initiates an auditing process, which is further illustrated by reference to FIG. 7. Referring to FIG. 7, a sequence diagram depicting a process 700 by which the system 200 audits the images and the remote facilities. At 702, the server software application sends the workstation 224 a notification message notifying the workstation 224 the variance in the two images. The notification message can be, for example, an Email message or a proprietary application message. In one implementation, the two images (or only the second image) are included in or attached to the notification message. Alternatively, the notification message indicates a location (such as a URL (meaning Uniform Resource Locator) of the two images. In a further implementation, the server software application indexes the second image within a video clip, and includes an URL to the video at the location of the indexed second image.

When the notification message does not include the two images, at 704, the workstation software application running on the workstation 224 requests the server software application for the images. In response, at 706, the server software application returns the images. For example, the request is initiated when a user of the workstation 224 clicks the URL to the images within a web page; and the returned images are displayed by a web browser. In a further implementation, at 708, the workstation software application requests for the corresponding video clip containing the two images, or additional still images, captured and uploaded by the imaging device 204. More generally stated, at 708, the workstation software application requests for a set of images for auditing the facility 10. The set of images is thus said to correspond to the two images. At 710, the server software application returns the video clip or additional images to the workstation 224. For example, the URL to the video clip is returned, clicking of which causes the playback of the video clip. The playback starts from the location of the two images, the beginning, or any position selected by the user of the video clip.

The video clip is recorded by the imaging device 204, which uploads it to the server 218 running the server software application, or a FTP file server within the server system 218. When the imaging device 204 uploads captured images to the FTP server, the server software application then periodically retrieves the images and/or video clips from the FTP server. In such a case, it is also said that the server software application retrieves the images from the imaging devices 204 and 206; and uploading images to the FTP server is also said to be uploading the images to the server 218. The FTP server can be implemented in software running one or more of the servers 218. A video clip is collection of sequential images (meaning still images or frames). Accordingly, recording a video clip is also said to be capturing images.

The user of the workstation 224 watches and examines the two images and/or the video clip to determine the nature of the variance. For example, the variance is caused by the presence of a tower climber, the presence of a bird, a change to an equipment, etc. When the climber is detected, the user can determine the identity of the climber, whether the climber complies with all requirements (such as safety requirements regulated by government and tower owner), etc. In certain geographical areas, the presence of certain bird species on a remote facility dictates that any operations on and access to the facility 10 cannot be conducted. The change to equipment on the facility 10 can be installing an equipment, modifying an existing equipment, or removing an equipment. The user then indicates to the workstation software application the nature of the variance, i.e., an audit result.

It should be noted that the audit result is based on the two images, the variance, and the set of images. Alternatively, the workstation 224 does not perform the elements 708 and 710. In such a case, the audit result is based on the two images and the variance.

At 714, the workstation software application sends the audit result to the server 218. The audit result can be, for example, a code or a description indicating the conclusion of the audit. At 716, the server software application stores the audit result into the database 220. In a further implementation, at 718, the server 218 sends a notification indicating the audit result to the communication device 234 over a network (such as Internet or public phone network) connection. The communication device 234 can be a telephone, a smart phone, a workstation computer, a server computer, etc. For example, when a climber violates a safety protocol, the audit result notification is sent to the communication device 234 operated by an operator of the facility 10, or a telecommunication carrier renting the RAD center 308. The notification can be an automatic phone call, an Email, a text message, etc. Alternatively, at 720, the workstation 224 sends the notification to the device 234; or the user of the workstation 224 places a phone call to the device 234.

As an additional example, when a bird of a specific species is determined to be on the facility 10, the notification is sent such that no maintenance work on the facility can be performed until the bird leaves the facility 10. As still a further example, when an equipment (such as the imaging device 204 or a telecommunication device on the facility 10) is determined to be changed (either changed properly or improperly) or damaged, the notification of this audit result is sent to the device 234. The notification may or may not include the two images.

There are situations where a customer, such as the operator of the facility 10 or a telecommunication carrier renting a portion of the facility 10, desires to view the current or past activities (or state) of the facility 10. In such a case, at 722, the communication device 234 (such as a server of the customer) sends a request indicating the demand for the relevant images to the server 218. The requested images correspond to and start from a specific time. At 724, the server 218 provides the images to the device 234.

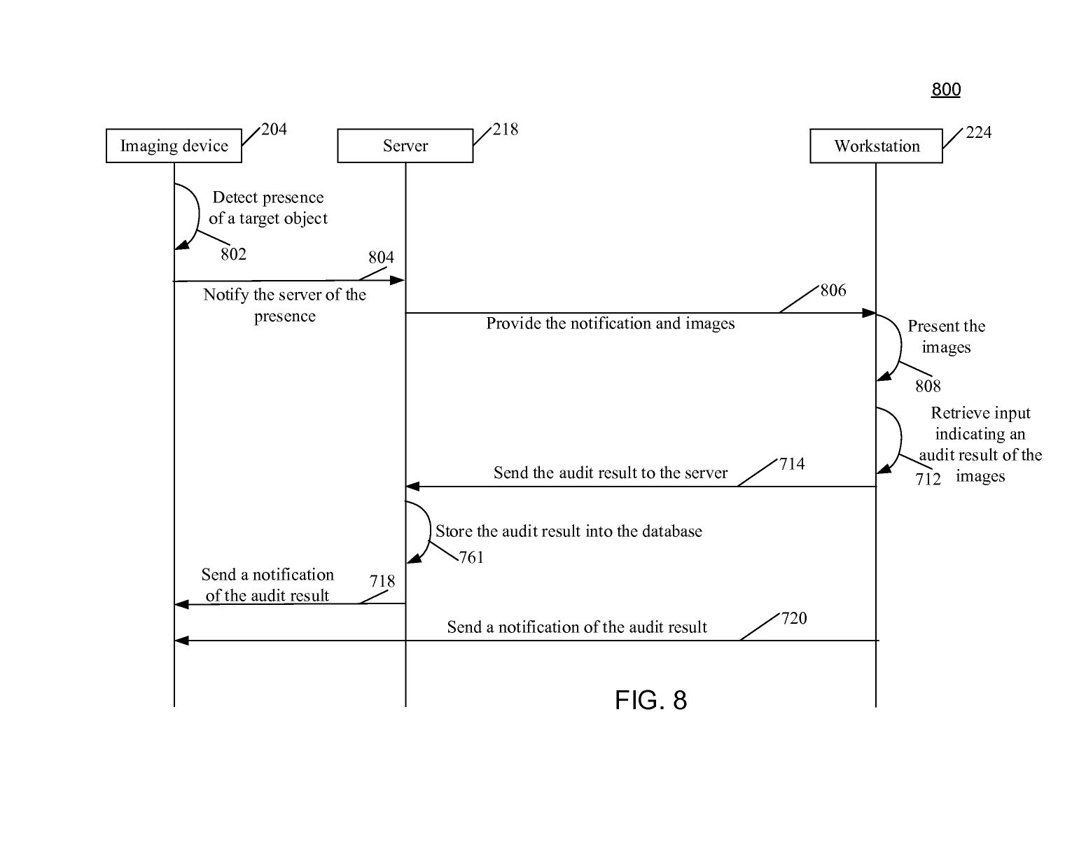

Object detection device, such as the PIR 322, is capable of detecting the presence of objects meeting a set of settings on the RAD center 308. For example, the PIR is configured to detect a human being (or a bird) when the size and temperature indicating a human being are set. The object detection and audit process is further illustrated by reference to FIG. 8.

Turning to FIG. 8, a sequence diagram depicting a process by which a remote facility is monitored and audited is shown and generally indicated at 800. When the target object is detected, at 802, the imaging device 204 is notified by the PIR 322 of the presence of the target object. In response, at 804, the imaging device 204 sends a notification to the server 218. In addition, at 804, the imaging device 204 uploads captured images (such as still images or a video clip) including the target object. These captured images are said to correspond to the notification.

At 806, the server 218 provides the notification and the images to the workstation 224. In one implementation, at 808, the workstation 224 repeatedly plays back the images (or a video clip) to attract the attention of an operator, who might be monitoring numerous workstations 224 corresponding to multiple imaging devices on the same or different facilities 10. The repetitive playback shows the latest activity, indicated by the image variance or the presence of the target object, on the facility 10. Based on the images, a user enters an audit result. At 712, the workstation software application receives the user's input indicating the audit result.

In a further implementation, the server software application provides a time lapse function, by which the workstation 224 plays back images captures by the imaging device 204 over a predetermined amount of time, such as a month. In such a case, the intervals between consecutive images are, for example, one hour.

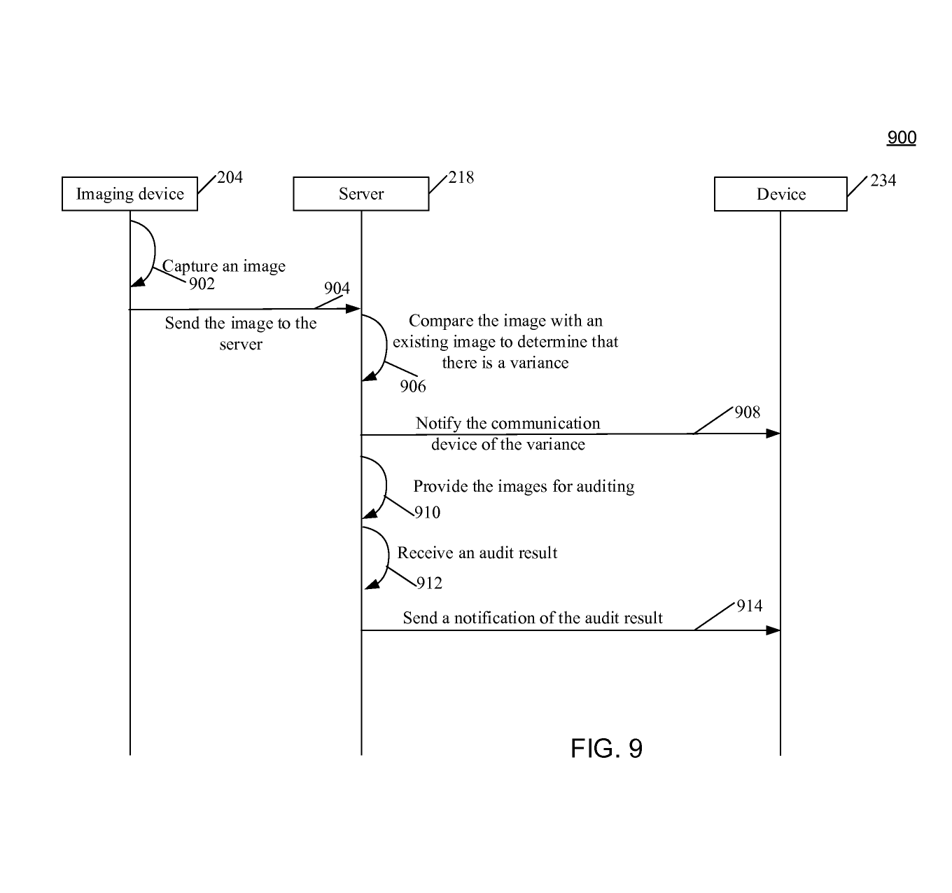

Referring to FIG. 9, a sequence diagram depicting a process 900 by which the system 200 monitors and audits the remote facility 10 is shown. At 902, the imaging device captures an image. The imaging device sends the image to the server 218. At 906, the server software application compares the received image with an existing image, such as an image captured earlier, to determine that there is an image variance between these two images. Regarded as a reference image, the existing image indicates a known state (such as initial installation or an upgrade of an equipment) of the facility 10. For example, the first image received at 402 is the reference image, while the second image received at 402 is the image that is retrieved at 904. At 908, the server software application notifies the communication device 234 of the variance. In a further implementation, at 910, the server software application provides these images to the workstation 224 for further auditing. At 912, the server software application receives an audit result. At 914, the server software application sends the audit result to the communication device 234.

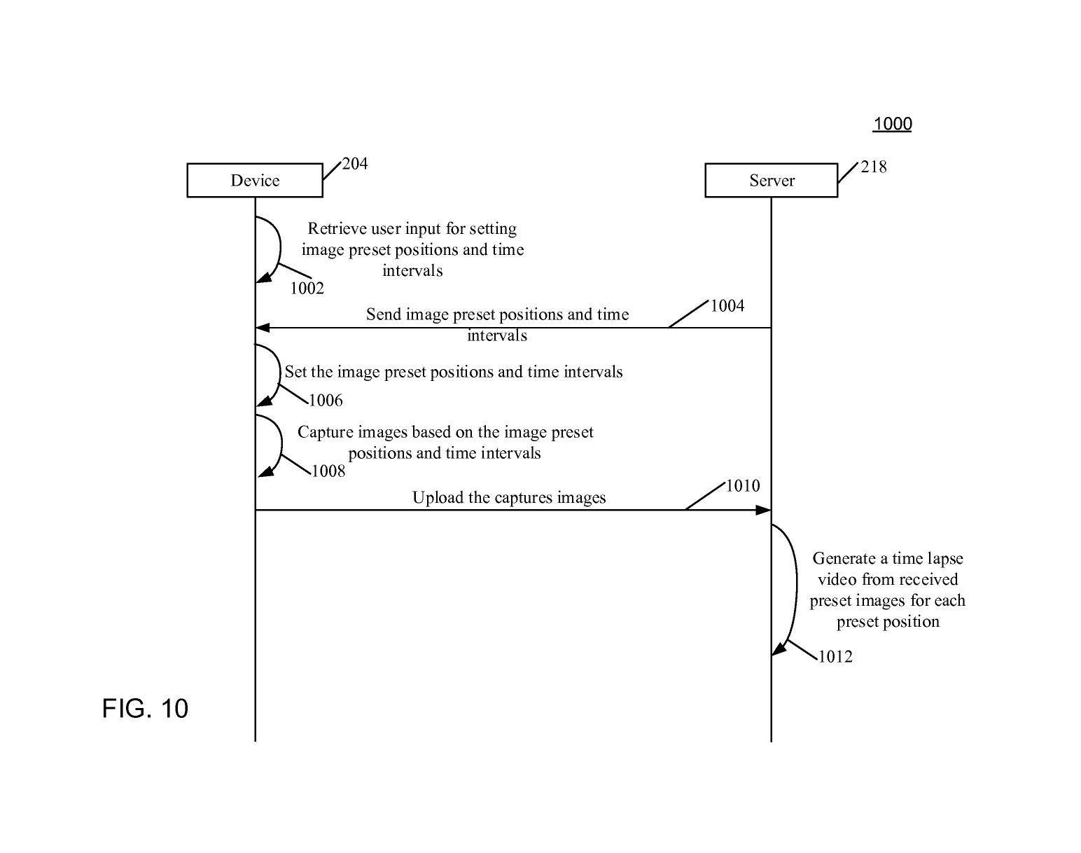

In one implementation, the imaging devices 204 and 206 support preset PTZ positions. A software program running on the device 204 (such as a digital camera supporting PTZ) sets a preset position and a time interval for taking images periodically. The preset images taken based on the present position and time interval are then uploaded to a server and form a time lapse video. The present images and time lapse videos are further illustrated by reference to FIG. 10, a sequence diagram depicting a process 1000 by which the system 200 captures preset images and generates time lapse videos.

At 1002, the software program running on the device 204 retrieves user input for setting image one or more preset positions and corresponding one or more time intervals. In one implementation, a single time interval is used for each preset position. The preset positions and corresponding time intervals can also be specified by the server 218. In such a case, at 1004, the server software application running on the server 218 sends the image preset positions and time intervals to the imaging device 204. At 1006, the software program sets the image preset positions and the corresponding time intervals. At 1008, the imaging device 204 captures an image at each preset position at the corresponding time interval (such as every hour). At 1010, the imaging device 204 uploads the captured preset images to the server 218. At 1012, the server software application groups the preset images based on the preset position in a timely order. The preset images for each preset position form a time lapse video.

It should be noted that the present images can be selected to generate a time lapse video. For example, elements of the process 500 and/or 600 are executed to determine image variation between consecutive present images of a specific preset position, and filter off unchanged preset images. In other words, when there is not an image variation between two consecutive images, the newer image is not selected or used for generating a time lapse video.

In a further implementation, images (such as preset images) captured after sunset and before sunrise are filtered off in generating time lapse videos. In other words, images captured during night are not used to generate time lapse videos. The time of sunset and the time sunrise are also determined based on the captured image. On some remote facilities, lighting devices are deployed. Images captured while the lighting devices are turned off are also excluded from time lapse videos. As used herein, after sunset and before sunrise, it is said that light is off; after sunrise and before sunset, it is said that light is on. Similarly, when the lighting devices on a remote facility are turned off, it is said that light is off; when the lighting devices are turned on, it is said that light is on.

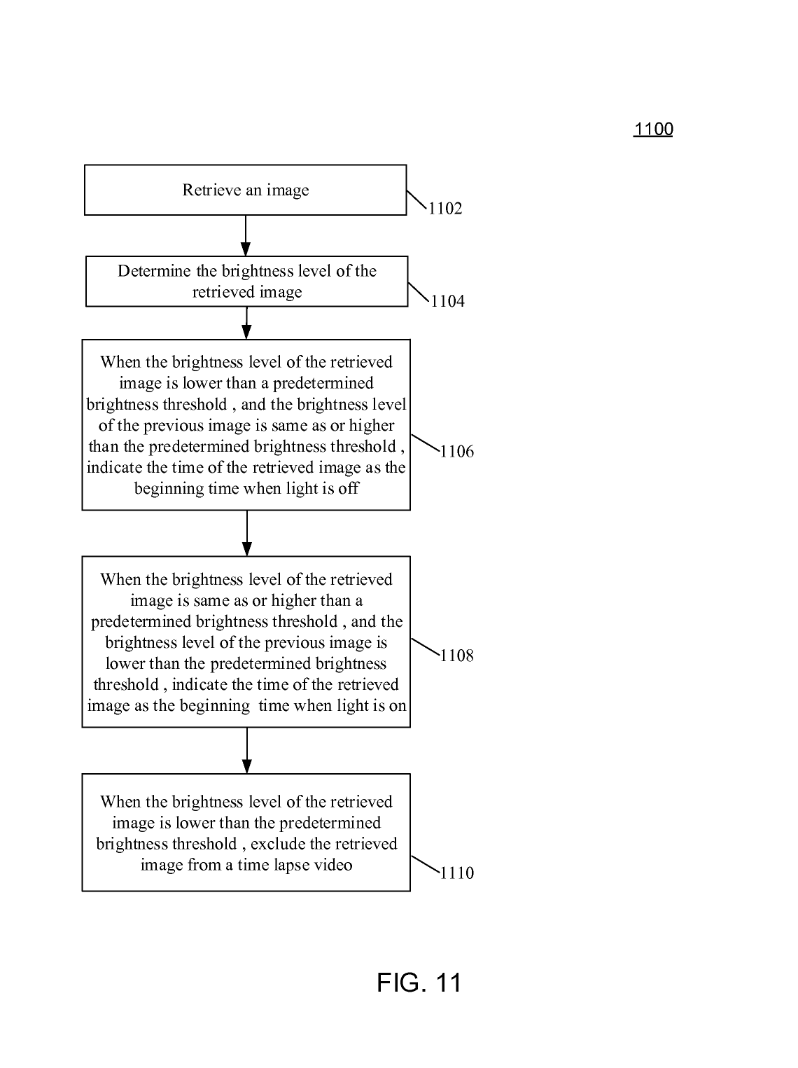

The process of filtering off images captured while light is off is further illustrated by reference to FIG. 11. Referring to FIG. 11, a flowchart depicting a process by which the server software application running on the server 218 filters off images captured while light is off is shown and generally indicated at 1100. The server software application retrieves and processes more than one preset images of a particular preset position. At 1102, the server software application retrieves an image from, for example, the imaging device 204 or a FTP file server. At 1104, the server software application determines the brightness level of the retrieved image. For example, the brightness level of the retrieved image is calculated as the average brightness level of all the pixels within the image. The brightness level is defined as the average value of its R, G and B values when the pixel's color is expressed in the (R, G, B) color format.

At 1106, the server software application determines whether the brightness level of the retrieved image is lower than a predetermined brightness threshold, and the brightness level of the previous image (such as the image retrieved immediately prior to the current retrieved image retrieved at 1102) at is same as or higher than the predetermined brightness threshold. If so, at 1106, the server software application indicates that the time when the retrieved image is captured is the beginning time when light is off. For example, the server software application records the light off time into the database 220, and provides the light off time to interested parties. The predetermined brightness threshold corresponds to sunset or sunrise.

At 1108, the server software application determines whether the brightness level of the retrieved image is same as or higher than a predetermined brightness threshold, and the brightness level of the previous image is lower than the predetermined brightness threshold. If so, at 1108, the server software application indicates that the time when the retrieved image is captured is the beginning time when light is on. For example, the server software application records the light on time into the database 220, and provides the light off time to interested parties. At 1110, the server software application excludes the retrieved image from a time lapse video when the brightness level of the retrieved image is lower than the predetermined brightness threshold.

Obviously, many additional modifications and variations of the present disclosure are possible in light of the above teachings. Thus, it is to be understood that, within the scope of the appended claims, the disclosure may be practiced otherwise than is specifically described above. For example, the server software application includes a set of software components and back ground processes.

The foregoing description of the disclosure has been presented for purposes of illustration and description, and is not intended to be exhaustive or to limit the disclosure to the precise form disclosed. The description was selected to best explain the principles of the present teachings and practical application of these principles to enable others skilled in the art to best utilize the disclosure in various embodiments and various modifications as are suited to the particular use contemplated. It is intended that the scope of the disclosure not be limited by the specification, but be defined by the claims set forth below. In addition, although narrow claims may be presented below, it should be recognized that the scope of this invention is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional inventions are not dedicated to the public and the right to file one or more applications to claim such additional inventions is reserved.

What is claimed is:

1. A system for monitoring and auditing a remote facility, the system comprising:
i) a database;
ii) a server including a processor, a network interface coupled to said processor and adaptively coupled to said database, and a server software application running on said processor, said server adapted to communicate with a plurality of imaging devices and a set of workstations, said plurality of imaging devices including a first imaging device mounted to a remote facility, said first imaging device adapted to capture images and upload said captured images to said server, said set of workstations including a first workstation;
iii) said server software application adapted to:
1) from said first imaging device, retrieve a first image and a second image via said network interface;
2) determine a time for both said first image and said second image;
3) compare said first image with said second image to determine that there is an image variance between said first image and said second image; and
4) in response to said image variance, audit said remote facility.

2. The system of claim 1, wherein said server software application audits said remote facility by:
i) notifying said first workstation of said image variance;
ii) from said first workstation, receiving a first audit result based on said first and second images and said variance via said network interface; and
iii) sending said first audit result to a communication device via said network interface.

3. The system of claim 2, wherein said server software application further audits said remote facility by:
i) receiving a request from said first workstation for a set of images corresponding to said first and second images via said network interface; and
ii) sending said set of images to said first workstation via said network interface, wherein said first audit result is based on said first and second images, said variance and said set of images.

4. The system of claim 3, wherein said set of images is a video clip.

5. The system of claim 1, wherein said server software application is further adapted to:
i) receiving a notification and corresponding images from said first imaging device indicating a presence of a target object;
ii) sending said corresponding images to said first workstation for auditing;
iii) from said first workstation, receiving a second audit result, wherein said second audit result is based on said corresponding images; and
iv) sending said second audit result to a communication device.

6. The system of claim 5, wherein said corresponding images are a video clip.

7. The system of claim 1, wherein said server software application is further adapted to notify a communication device of said image variance.

8. The system of claim 1, wherein said server software application is further adapted to:
i) receiving a request for images corresponding to a predetermined time from a communication device; and
ii) returning said requested images to said communication device.

9. The system of claim 1, wherein said server software application compares said first image with said second image by:
i) retrieving a setting from said database;
ii) dividing said first and second images into a set of corresponding sections based on said setting;
iii) selecting a pair of corresponding sections within said set of corresponding sections;
iv) comparing corresponding pixels within said selected pair of corresponding sections to derive a difference measure; and
v) where said difference measure is over a predetermined threshold, indicating that said image variance exists.

10. The system of claim 1, wherein said server software application further compares said first image with said second image by excluding one or more pairs of corresponding sections of said set of corresponding sections from image comparison.

11. The system of claim 1, wherein said server software application compares said first image with said second image by:
i) retrieving a setting indicating a target object from said database;
ii) comparing said first image with said second image to locate a first changed pixel within said second image;
iii) grouping changed pixels within said second image that are connected to said first changed pixel; and
iv) checking whether a size of said grouped pixels meets said setting; and
v) where said size of said grouped pixels meets said setting, indicating that said image variance exists.

12. A method for monitoring and auditing a remote facility, the method operating within a remote facility monitoring and auditing system and comprising:
i) a server within said monitoring and auditing system receiving a first image and a second image from an imaging device over a network interface of said server, said imaging device mounted to a remote facility and adapted to communicate with said server over a network connection;
ii) said server determining a time for both said first image and said second image;
iii) said server comparing said first image with said second image to determine that there is an image variance between said first image and said second image; and
iv) said server auditing said remote facility in response to said image variance.

13. The method of claim 12, wherein auditing said remote facility comprises:
i) notifying a workstation of said image variance, said workstation adapted to communicate with said server over a network connection;
ii) from said first workstation, receiving a first audit result based on said first and second images and said variance; and
iii) sending said first audit result to a communication device over a network connection.

14. The method of claim 13, wherein auditing said remote facility further comprises:
i) receiving a request from said workstation for a set of images corresponding to said first and second images; and
ii) sending said set of images to said workstation, wherein said first audit result is based on said first and second images, said variance and said set of images.

15. The method of claim 12 further comprising:
i) receiving a notification and corresponding images from said imaging device indicating a presence of a target object;
ii) sending said corresponding images to said workstation for further auditing;
iii) from said workstation, receiving a second audit result, wherein said second audit result is based on said corresponding images; and
iv) sending said second audit result to said communication.

16. The method of claim 12 further comprising notifying a communication device of said image variance.

17. The method of claim 12 further comprising:
i) receiving a request for images corresponding to a predetermined time from a communication device; and
ii) returning said requested images to said communication device.

18. The method of claim 12, wherein comparing said first image with said second image comprises:
i) retrieving a setting from a database;
ii) dividing said first and second images into a set corresponding sections based on said setting;
iii) selecting a pair of corresponding sections within said set of corresponding sections;
iv) comparing corresponding pixels within said selected pair of corresponding sections to derive a difference measure; and
v) where said difference measure is over a predetermined threshold, indicating that said image variance exists.

19. The method of claim 18 further comprising excluding one or more pairs of corresponding sections of said set of corresponding sections from image comparison.

20. The method of claim 12, wherein comparing said first image with said second image comprises:
i) retrieving a setting indicating a target object from a database;
ii) comparing said first image with said second image to locate a first changed pixel within said second image;
iii) grouping changed pixels within said second image that are connected to said first changed pixel; and
iv) checking whether a size of said grouped pixels meets said setting; and
v) where said size of said grouped pixels meets said setting, indicating that said image variance exists.
